(19) United States
(12) Patent Application Publication
(10) Pub. No.: US 2021/0252675 A1
(43) Pub. Date: Aug. 19, 2021

(54) INTERCHANGEABLE TOOL HAND SOCKET WRENCH

(71) Applicant: SNA EUROPE INDUSTRIES IBERIA, S. A., Vitoria (ES)

(72) Inventor: Hodei LANDA FERNANDEZ DE LA BASTIDA, Vitoria (ES)

(21) Appl. No.: 17/131,100

(22) Filed: Dec. 22, 2020

(30) Foreign Application Priority Data
Feb. 14, 2020 (ES) 202030244

(51) Int. Cl. B25B 13/06; B25B 23/00

(52) U.S. Cl. CPC B25B 13/06; B25B 23/0035

(57) ABSTRACT

The interchangeable tool socket wrench is used with interchangeable heads. The wrench includes at least two identification areas. There is also an identification framework having at least one perimeter strip of geometric motifs, in the manner of knurling, and an annular identification motif.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This invention concerns the field of tools with interchangeable heads, of the screwdriver type, ratchet wrenches and similar, which use heads of different measures and metrics to adapt to the type of work to be done, such as the different types and sizes of screws, nuts, etc.

### 2. Description of Related Art Including Information Disclosed Under 37 CFR 1.97 and 37 CFR 1.98

At present and as a reference to the state of the art, sockets are known that have knurling at one of their ends, made by means of marks on their surface, at +/−45 degrees with respect to their axis. Said knurling has the sole function of improving the grip in case of manual use of the glass, being the same between different sizes of the same type of glass, without there being any appreciable difference between them, despite being applicable to different metrics and/or sizes of nuts and bolts.

With the current state of the art, an operator needing to use a glass for a particular task, needs to conduct several checks on the various alternatives available in the toolbox to find the one that has the features and measures appropriate to said task. For example, they have to verify that the size of the socket is suitable for the head of the screw to be tightened. Also, for correct and definitive selection, the shape of said head must be checked, which may be of the Philips type, slot, torx, etc., and it must also be verified that it is the appropriate size for the tool in which said head is going to be used, which may be a ratchet wrench, interchangeable head screwdriver, electric or pneumatic drill, etc., so that in a workshop, with a wide variety of tools available, considerable time is wasted in the search and verification of the right tool for the task at hand.

### BRIEF SUMMARY OF THE INVENTION

Faced with this state of affairs, the present invention refers to an interchangeable tool socket wrench, one of those intended to be used as interchangeable heads, characterized in that it contains at least two identification areas, being; an identification framework made up of at least one perimeter strip of geometric motifs (in the manner of knurling), and an annular identification motif.

Thanks to this configuration, a great versatility is obtained since two modes are used to quickly provide useful information for an operator who must carry out a task for which he needs to use an interchangeable head suitable for said task. The information provided by these identification areas is related to the metric, size of the tool required to use the socket, type of nut/bolt for which it is suitable, and its size. In this way, he can easily identify the characteristics of the different alternatives that he can count on in his toolbox or workshop, based on the information offered by the identification areas of each part, without even having to move them, since due to their configuration, being perimeter and annular, they are visible in any position it is found in, thus saving time and reducing errors. This is especially useful in environments where tool turnover is high and tools are not usually kept neat in their corresponding places in the shop, such as ad hoc receptacles, cases, etc.

In an example of configuration, the number of perimeter strips of geometric motifs, for example squares, could be related to the size of the square corresponding to the socket, so that the greater the number of strips, the larger the square, such that, for example, two strips could correspond to a one-quarter-inch square, while three strips could correspond to a three-eighths-inch square.

In the same manner, by means of the annular identification motif and its different colors, information will be given about the type of nut for which the socket is intended, such as hexagonal, torx, assigning a type of nut to each color.

Furthermore, making the identification network requires no special techniques, and the cutting or deformation methods currently used are suitable for this purpose.

An additional advantage of this identification network is that it also functions as a grip improvement in case of using the glass manually, in those cases where the force or reach of an additional tool such as a ratchet wrench or an elongated or angled handle is not required, that is, working like a knurling process that is common in tools.

Another feature of the invention is that the identification motif is constituted by an annular insertion slot in which a distinctive color material is incorporated, which may be paint, varnish, resin, polymeric composites or other materials.

Thanks to this configuration, the distinctive color material is in a recess below the general profile of the socket, thus being protected from friction with other materials, tools, parts, operators' hands, which, both due to the routine use of the tool and the treatment received by the part in a workshop, cannot always be the most careful, thus avoiding wear and loss of the material due to friction, erosion and/or removal, and maintaining the identifying function throughout the useful life of the tool.

This distinctive material will be used to provide information, based on the color of the material, so that according to said color, the type of glass is reported, for example, hexagonal, torx, bi-hexagonal, etc. or its metric.

Additionally, the way of filling the annular insertion slot with the distinctive colored material can also be used to provide information, for example, whether it protrudes from the general outline of the socket or is underneath, it can provide tactile information about the direction in which the socket has been caught, or for example, distinguish if the glass is impact or not.

Another feature of the invention is that the perimeter strip of geometric motifs is formed by rows of squares.

This allows an easy and rapid recognition of the strips that form the identification lattice, so that the process of counting said strips is fast, reliable and effortless.

An alternative construction is one in which the strips of geometric motifs are made up of circles.

This variation can provide better grip conditions in certain circumstances of use of the socket and present a different visual appearance, and, therefore, also provide other visual information, if they are alternated, for example.

Additionally, the strips of geometric motifs that form the perimeter strips can be formed by any geometric figure, such as triangles, hexagons, pentagons, hemispheres, etc., and the motifs that form each of the strips can alternate, so that, for example, a strip of squares could alternate with another of circles, or two of squares with one of triangles and another of circles, etc.

On the other hand, it should be noted that geometric motifs can be marked as high relief, as bas-relief, or as a combination of both formats, depending on the way they are manufactured.

### BRIEF DESCRIPTION OF THE SEVERAL VIEWS OF THE DRAWINGS

To better understand the nature of the invention, the attached drawings represent an industrial embodiment that is merely illustrative and non-limiting.

FIG. 1 shows a perspective view of an example of application of the invention, showing the socket (1), with the identification network (2), consisting of three perimeter strips with geometric motifs (2a), which in this case are formed by squares (2b).

At the bottom of FIG. 1, the identification motif (3) is shown, where it can be seen that the annular identification motif (3a) is formed by an annular groove insert (3b), inside which is introduced a distinctive colored material (3c).

In order to facilitate the understanding of the figure, the presence of the tool in which the socket would be used as an interchangeable head has been indicated in the lower part, and after the end of the socket, without it being part of the Invention.

FIG. 2 shows a perspective view of the same socket, but with two perimeter strips of geometric motifs (2a) instead of the three in FIG. 1, which would indicate a different square size. In an exemplary embodiment, two rows of squares correspond to a square of a quarter of an inch, while three rows correspond to a square of three-eighths of an inch.

FIG. 3 shows a perspective view of the same socket as FIG. 1, with a different color of the distinctive colored material (3c), which would indicate a different metric and type of head.

In these figures, the following references are indicated:
1.—Interchangeable tool socket wrench.
2.—Identification framework
2a—Perimeter strip of geometric motifs
2b—Perimeter strip of squares.
3.—Identification motif
3a—Annular identification motif
3b—Annular insertion groove
3c—Distinctive colored material

### DETAILED DESCRIPTION OF THE INVENTION

With regard to the above-listed drawings and references, in the attached drawings is illustrated a preferred mode of embodiment of the object of the invention, referring to an interchangeable tool socket wrench, which comprises an interchangeable tool socket wrench (1) containing an identifying framework (2) on its surface, formed by a perimeter strip of geometric motifs (2a), composed of at least one perimeter strip of squares (2b), and an identification motif (3) closer to the edge, formed by an annular identification motif (3a), which has an annular groove of insertion (3b), in which a distinctive colored material (3c) is embedded.

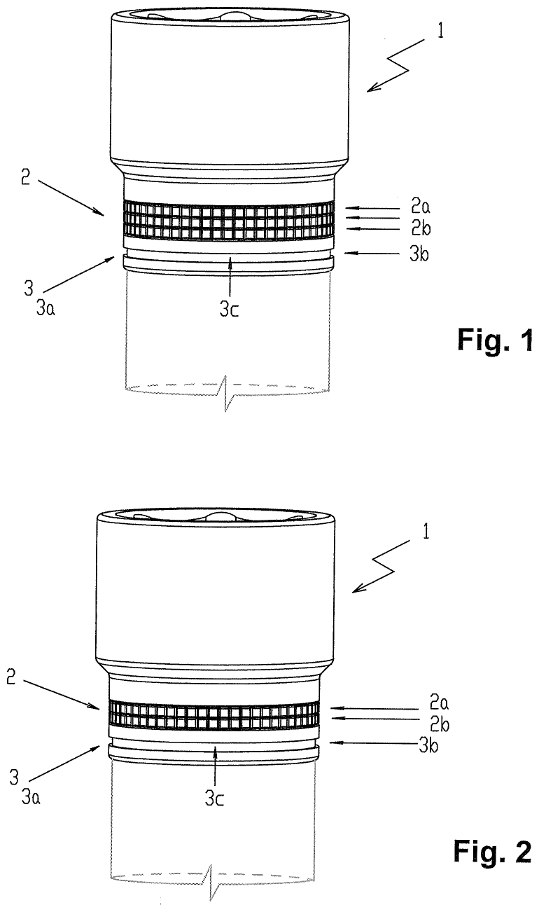

FIG. 1 shows an embodiment with three perimeter strips of squares (2b), which would correspond to a square size of three-eighths of an inch, while FIG. 2 shows an embodiment with two perimeter strips of squares, which would correspond to a square nut size of a quarter of an inch.

Similarly, the color of the distinctive colored material (3c) encodes the metric of the heads for which it applies (metric or imperial) and head type (hexagonal, for example).

With this configuration, whatever the position of the workpiece, and whatever the site where it is, whether it is a tool box, case, working platform, etc, a sufficient portion of both identification areas, the identification framework (2) and the identification motif (3) is always visible, so as to quickly and easily obtain the information necessary to select the appropriate socket.

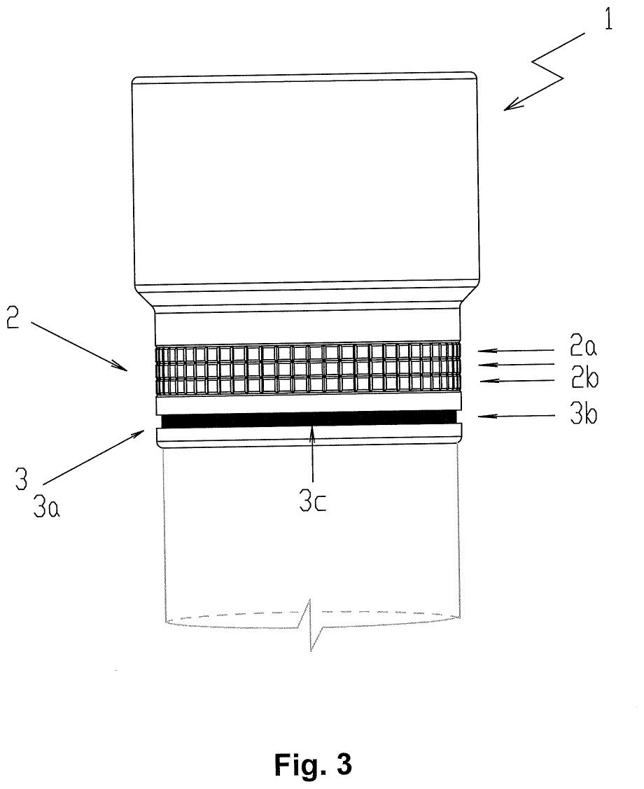

In this manner, by way of two easily manufactured identification areas a very large number of possibilities of identification is achieved. Thus, FIG. 3 shows how the identification motif (3) is configured as an annular insertion groove (3b) in which, having added a distinctive colored material (3c), in this case black, the type of head of the interchangeable tools socket wrench (1) is determined, and by means of the three perimeter strips of squares (2b) the size of three-eighths of an inch of the square.

Variations in materials, shape, size and arrangement of the component elements, described in a non-limiting manner, do not alter the essentiality of this invention, this being sufficient to proceed with its reproduction by an expert.

1. An interchangeable tool hand socket wrench with interchangeable heads, comprising:
at least two identification areas; and
an identifying framework being comprised of at least one perimeter strip of geometric motifs, and an annular identification motif.

2. The interchangeable tool hand socket wrench according to claim 1, wherein an identification motif is comprised of an annular groove of insertion, wherein a distinctive colored material is incorporated.

3. The interchangeable tool hand socket wrench according to claim 1, wherein the perimeter strip of geometric motifs is comprised of perimeter strips of squares.

4. The interchangeable tool hand socket wrench according to claim 1, wherein the perimeter strip of geometric motifs is comprised of circles.
